(19) United States
(12) Patent Application Publication
(10) Pub. No.: US 2017/0228062 A1
(43) Pub. Date: Aug. 10, 2017

(54) TOUCH OBJECT DETECTION FOR TOUCH SENSORS

(71) Applicants: Luben Hristov, Sofia (BG); Samuel Brunet, Cowes (GB); Richard Collins, Southampton (GB); Stephan Thaler, Buchloe (DE)

(72) Inventors: Luben Hristov, Sofia (BG); Samuel Brunet, Cowes (GB); Richard Collins, Southampton (GB); Stephan Thaler, Buchloe (DE)

(21) Appl. No.: 15/040,889

(22) Filed: Feb. 10, 2016

(51) Int. Cl. G06F 3/044

(52) U.S. Cl. CPC G06F 3/044; G06F 2203/04112

(57) ABSTRACT

In one embodiment, a system includes one or more processors and one or more memory units storing logic. The logic is configured to, when executed by the processors, cause the processors to perform operations including detecting a position of a touch object within an area of a touch sensor during a period of time when an injected signal is present on one or more of the plurality of electrodes of the touch sensor. The injected signal is generated by a signal source and electrically coupled to the touch sensor through a source electrode distinct from the plurality of electrodes of the touch sensor. The operations further include identifying a source of the touch object based at least in part on a proximity of the injected signal present on one or more of the plurality of electrodes to the detected position of the touch object.

### TECHNICAL FIELD OF THE INVENTION

This disclosure generally relates to touch sensors.

### BACKGROUND

In an example scenario, a touch sensor detects the presence and position of an object (e.g., a user's finger or a stylus) within a touch-sensitive area of touch sensor array overlaid on a display screen, for example. In a touch-sensitive-display application, a touch sensor array allows a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other device. A control panel on a household or other appliance may include a touch sensor.

There are a number of different types of touch sensors, such as (for example) resistive touch sensors, surface acoustic wave touch sensors, and capacitive touch sensors. In one example, when an object physically touches a touch screen within a touch-sensitive area of a touch sensor of the touch screen (e.g., by physically touching a cover layer overlaying a touch sensor array of the touch sensor) or comes within a detection distance of the touch sensor (e.g., by hovering above the cover layer overlaying the touch sensor array of the touch sensor), a change in capacitance may occur within the touch screen at a position of the touch sensor of the touch screen that corresponds to the position of the object within the touch sensitive area of the touch sensor. A touch sensor controller may process the change in capacitance to determine the position of the change of capacitance within the touch sensor (e.g., within a touch sensor array of the touch sensor).

### BRIEF DESCRIPTION OF THE DRAWINGS

For a more complete understanding of the present disclosure and its advantages, reference is made to the following descriptions, taken in conjunction with the accompanying drawings, in which:

FIG. 1A illustrates an example touch sensor array with an example touch sensor controller, according to an embodiment of the present disclosure;

FIG. 1B illustrates an example mechanical stack for a touch sensor, according to an embodiment of the present disclosure;

FIG. 2 illustrates an example implementation of a touch sensor, according to an embodiment of the present disclosure;

FIG. 3A illustrates an example touch sensor and touch-sensor controller configured for a touch-detection mode of operation, according to an embodiment of the present disclosure;

FIG. 3B illustrates an example touch sensor and touch-sensor controller configured for a source-identification mode of operation, according to an embodiment of the present disclosure;

FIG. 4 illustrates example signals of a touch-sensor controller during an example dual-measurement cycle, according to an embodiment of the present disclosure; and

FIG. 5 illustrates an example method for touch detection and source identification using a touch-sensor controller, according to an embodiment of the present disclosure.

### DETAILED DESCRIPTION OF EXAMPLE EMBODIMENTS

Capacitive touch sensors can be used to detect the presence of an object (e.g., a finger or a stylus) that is physically touching a touch screen within a touch-sensitive area of a touch sensor of the touch screen (e.g., by physically touching a cover layer overlaying a touch sensor array of the touch sensor) or that is within a detection distance of the touch sensor (e.g., by hovering above the cover layer overlaying the touch sensor array of the touch sensor). For example, in some implementations, a touch sensor controller drives electrodes of the touch sensor with a drive signal and analyzes sense signals sensed from the same or different electrodes, depending on the touch sensing technology used, to determine the presence and/or location of a touch object. For purposes of an embodiment of this description, an object (e.g., a finger or stylus) being in proximity to a touch sensor includes an object (e.g., a finger or a stylus) that is physically touching a touch screen within a touch-sensitive area of a touch sensor of the touch screen (e.g., by physically touching a cover layer overlaying a touch sensor array of the touch sensor) or that is within a detection distance of the touch sensor (e.g., by hovering above the cover layer overlaying the touch sensor array of the touch sensor). Additionally, in one embodiment, a touch sensor detecting whether an object is present includes the touch sensor detecting whether the object is in proximity to the touch sensor.

In certain implementations, a touch sensor identifies the source of the touch object. In automotive applications, for example, it may be useful for the touch sensor to distinguish a touch associated with the person in the driver seat from a touch associated with the person in the passenger seat. This information could be used to modify the behavior of a touch screen based on the identity of the person touching it (e.g., whether the person is in the driver seat or not). For instance, when the car is in motion or above a certain speed, touches by the driver could be ignored, while touches by the passenger are still accepted.

As another example, in conferencing applications, it may be desirable for the touch sensor to distinguish a touch associated with a first participant in a meeting room from a touch associated with a second participant in a meeting room. For instance, touches from the first person could create annotations on a document that identify the first person by name or by position in the room (e.g., first chair, second chair, etc.), and likewise for touches from the second person.

The present disclosure provides techniques to identify the source of a touch object using one or more injected signals. For example, a source electrode can be embedded in a chair and connected to a signal source. When the person sitting in the chair touches the touch sensor, the injected signal generated by the signal source couples to the touch sensor at the location of the touch. The sensor can detect the injected signal at that location and identify the touch as coming from the person sitting in the chair. Conversely, when a person not sitting in the chair (e.g., standing, or sitting in a different chair) touches the touch sensor, the injected signal generated by the signal source will not couple to the touch sensor at the location of that touch. The sensor can then detect that the injected signal is not present (or not strongly present) at that location and identify the touch as coming from someone other than the person sitting in the chair.

The present disclosure also provides techniques to detect the position of the touch object relative to the touch screen even when these injected signals are present on the touch sensor. In some circumstances, the injected signals, while useful for identifying the source of the touch object, could interfere with detection and location of a touch. The system described here avoids and/or minimizes the interference by performing processing to suppress the injected signal when detecting or localizing a touch. Consequently, the signal source generating the injected signal may operate asynchronously from the touch controller and/or touch sensor. This may eliminate the need for connections between the signal source and the touch controller and/or touch sensor to synchronize their timing and operations.

In one embodiment, a system includes one or more processors and one or more memory units coupled to the one or more processors, the one or more memory units collectively storing logic. The logic is configured to, when executed by the one or more processors, cause the one or more processors to perform operations including detecting a position of a touch object within an area of a touch sensor during a period of time when an injected signal is present on one or more of the plurality of electrodes of the touch sensor. The injected signal is generated by a signal source and electrically coupled to the touch sensor through a source electrode distinct from the plurality of electrodes of the touch sensor. For purposes of this disclosure, electrical coupling encompasses (1) galvanic coupling, (2) capacitive coupling, or (3) two or more electrically conductive elements being physically coupled together such that electrons may pass from one of such electrically conductive elements to the other of such electrically conductive elements. The operations further include identifying a source of the touch object based at least in part on a proximity of the injected signal present on one or more of the plurality of electrodes to the detected position of the touch object.

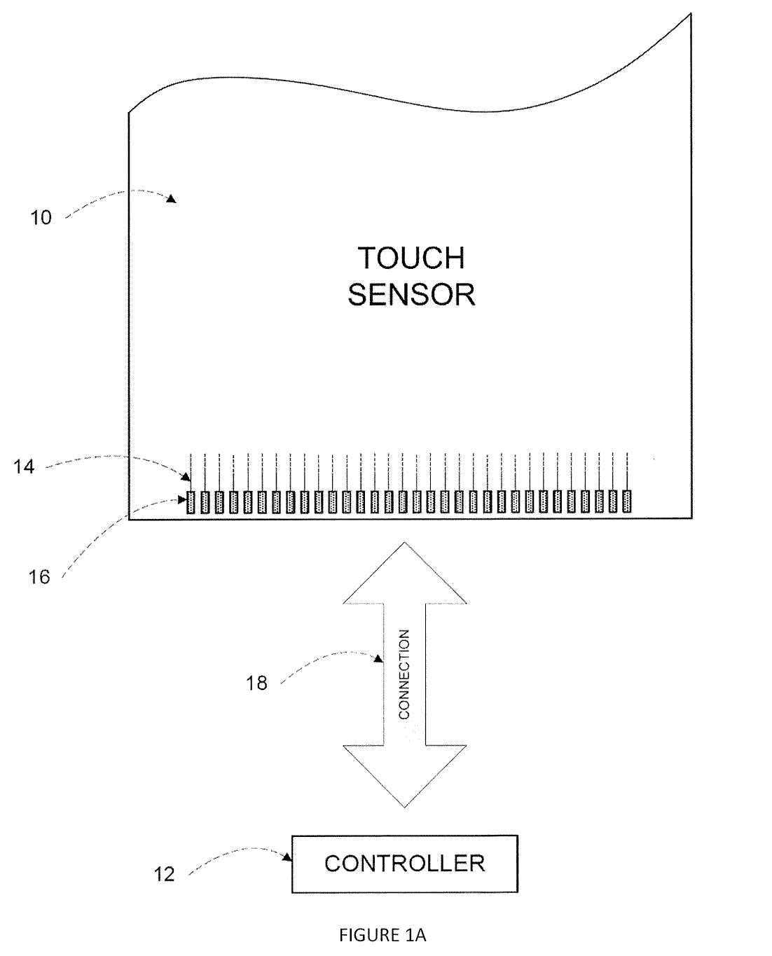

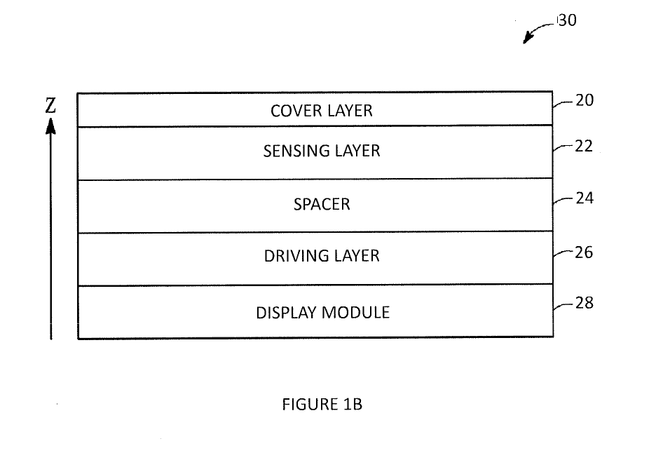

FIG. 1A illustrates an example touch sensor array with an example touch sensor controller according to an embodiment of the present disclosure. Touch sensor array 10 and touch sensor controller 12 detect the presence and position of a touch or the proximity of an object within a touch-sensitive area of touch sensor array 10. Reference to a touch sensor array may encompass both touch sensor array 10 and its touch sensor controller. Similarly, reference to a touch sensor controller may encompass both touch sensor controller 12 and its touch sensor array. Touch sensor array 10 includes one or more touch-sensitive areas. In one embodiment, touch sensor array 10 includes an array of electrodes disposed on one or more substrates, which may be made of a dielectric material. Reference to a touch sensor array may encompass both the electrodes of touch sensor array 10 and the substrate(s) on which they are disposed. Alternatively, reference to a touch sensor array may encompass the electrodes of touch sensor array 10, but not the substrate(s) on which they are disposed.

In one embodiment, an electrode is an area of conductive material forming a shape, such as for example a disc, square, rectangle, thin line, other shape, or a combination of these shapes. One or more cuts in one or more layers of conductive material may (at least in part) create the shape of an electrode, and the area of the shape may (at least in part) be bounded by those cuts. In one embodiment, the conductive material of an electrode occupies approximately 100% of the area of its shape. For example, an electrode may be made of indium tin oxide (ITO) and the ITO of the electrode may occupy approximately 100% of the area of its shape (sometimes referred to as 100% fill). In one embodiment, the conductive material of an electrode occupies less than 100% of the area of its shape. For example, an electrode may be made of fine lines of metal or other conductive material (FLM), such as for example copper, silver, or a copper- or silver-based material, and the fine lines of conductive material may occupy approximately 5% of the area of its shape in a hatched, mesh, or other pattern. Reference to FLM encompasses such material. Although this disclosure describes or illustrates particular electrodes made of particular conductive material forming particular shapes with particular fill percentages having particular patterns, this disclosure contemplates electrodes made of other conductive materials forming other shapes with other fill percentages having other patterns.

The shapes of the electrodes (or other elements) of a touch sensor array 10 constitute, in whole or in part, one or more macro-features of touch sensor array 10. One or more characteristics of the implementation of those shapes (such as, for example, the conductive materials, fills, or patterns within the shapes) constitute in whole or in part one or more micro-features of touch sensor array 10. One or more macro-features of a touch sensor array 10 may determine one or more characteristics of its functionality, and one or more micro-features of touch sensor array 10 may determine one or more optical features of touch sensor array 10, such as transmittance, refraction, or reflection.

Although this disclosure describes a number of example electrodes, the present disclosure is not limited to these example electrodes and other electrodes may be implemented. Additionally, although this disclosure describes a number of example embodiments that include particular configurations of particular electrodes forming particular nodes, the present disclosure is not limited to these example embodiments and other configurations may be implemented. In one embodiment, a number of electrodes are disposed on the same or different surfaces of the same substrate. Additionally or alternatively, different electrodes may be disposed on different substrates. Although this disclosure describes a number of example embodiments that include particular electrodes arranged in specific, example patterns, the present disclosure is not limited to these example patterns and other electrode patterns may be implemented.

A mechanical stack contains the substrate (or multiple substrates) and the conductive material forming the electrodes of touch sensor array 10. For example, the mechanical stack may include a first layer of optically clear adhesive (OCA) beneath a cover panel. The cover panel may be clear and made of a resilient material for repeated touching, such as for example glass, polycarbonate, or poly(methyl methacrylate) (PMMA). This disclosure contemplates cover panel being made of any material. The first layer of OCA may be disposed between the cover panel and the substrate with the conductive material forming the electrodes. The mechanical stack may also include a second layer of OCA and a dielectric layer (which may be made of PET or another material, similar to the substrate with the conductive material forming the electrodes). As an alternative, a thin coating of a dielectric material may be applied instead of the second layer of OCA and the dielectric layer. The second layer of OCA may be disposed between the substrate with the conductive material making up the electrodes and the dielectric layer, and the dielectric layer may be disposed between the second layer of OCA and an air gap to a display of a device including touch sensor array 10 and touch sensor controller 12. For example, the cover panel may have a thickness of approximately 1 millimeter (mm); the first layer of OCA may have a thickness of approximately 0.05 mm; the substrate with the conductive material forming the electrodes may have a thickness of approximately 0.05 mm; the second layer of OCA may have a thickness of approximately 0.05 mm; and the dielectric layer may have a thickness of approximately 0.05 mm.

Although this disclosure describes a particular mechanical stack with a particular number of particular layers made of particular materials and having particular thicknesses, this disclosure contemplates other mechanical stacks with any number of layers made of any materials and having any thicknesses. For example, in one embodiment, a layer of adhesive or dielectric may replace the dielectric layer, second layer of OCA, and air gap described above, with there being no air gap in the display.

One or more portions of the substrate of touch sensor array 10 may be made of polyethylene terephthalate (PET) or another material. This disclosure contemplates any substrate with portions made of any material(s). In one embodiment, one or more electrodes in touch sensor array 10 are made of ITO in whole or in part. Additionally or alternatively, one or more electrodes in touch sensor array 10 are made of fine lines of metal or other conductive material. For example, one or more portions of the conductive material may be copper or copper-based and have a thickness of approximately 5 microns (μm) or less and a width of approximately 10 μm or less. As another example, one or more portions of the conductive material may be silver or silver-based and similarly have a thickness of approximately 5 μm or less and a width of approximately 10 μm or less. This disclosure contemplates any electrodes made of any materials.

In one embodiment, touch sensor array 10 implements a capacitive form of touch sensing. In a mutual-capacitance implementation, touch sensor array 10 may include an array of drive and sense electrodes forming an array of capacitive nodes. A drive electrode and a sense electrode may form a capacitive node. The drive and sense electrodes forming the capacitive node are positioned near each other but do not make electrical contact with each other. Instead, in response to a signal being applied to the drive electrodes for example, the drive and sense electrodes capacitively couple to each other across a space between them. A pulsed or alternating voltage applied to the drive electrode (by touch sensor controller 12) induces a charge on the sense electrode, and the amount of charge induced is susceptible to external influence (such as a touch or the proximity of an object). When an object touches or comes within proximity of the capacitive node, a change in capacitance may occur at the capacitive node and touch sensor controller 12 measures the change in capacitance. By measuring changes in capacitance throughout the array, touch sensor controller 12 determines the position of the touch or proximity within touch-sensitive areas of touch sensor array 10.

In a self-capacitance implementation, touch sensor array 10 may include an array of electrodes of a single type that may each form a capacitive node. When an object touches or comes within proximity of the capacitive node, a change in self-capacitance may occur at the capacitive node and touch sensor controller 12 measures the change in capacitance, for example, as a change in the amount of charge implemented to raise the voltage at the capacitive node by a pre-determined amount. As with a mutual-capacitance implementation, by measuring changes in capacitance throughout the array, touch sensor controller 12 determines the position of the touch or proximity within touch-sensitive areas of touch sensor array 10. This disclosure contemplates any form of capacitive touch sensing.

In one embodiment, one or more drive electrodes together form a drive line running horizontally or vertically or in other orientations. Similarly, in one embodiment, one or more sense electrodes together form a sense line running horizontally or vertically or in other orientations. As one particular example, drive lines run substantially perpendicular to the sense lines. Reference to a drive line may encompass one or more drive electrodes making up the drive line, and vice versa. Reference to a sense line may encompass one or more sense electrodes making up the sense line, and vice versa.

In one embodiment, touch sensor array 10 includes drive and sense electrodes disposed in a pattern on one side of a single substrate. In such a configuration, a pair of drive and sense electrodes capacitively coupled to each other across a space between them form a capacitive node. As an example self-capacitance implementation, electrodes of a single type are disposed in a pattern on a single substrate. In addition or as an alternative to having drive and sense electrodes disposed in a pattern on one side of a single substrate, touch sensor array 10 may have drive electrodes disposed in a pattern on one side of a substrate and sense electrodes disposed in a pattern on another side of the substrate. Moreover, touch sensor array 10 may have drive electrodes disposed in a pattern on one side of one substrate and sense electrodes disposed in a pattern on one side of another substrate. In such configurations, an intersection of a drive electrode and a sense electrode forms a capacitive node. Such an intersection may be a position where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates other configurations of electrodes forming nodes. Moreover, this disclosure contemplates other electrodes disposed on any number of substrates in any patterns.

As described above, a change in capacitance at a capacitive node of touch sensor array 10 may indicate a touch or proximity input at the position of the capacitive node. Touch sensor controller 12 detects and processes the change in capacitance to determine the presence and position of the touch or proximity input. In one embodiment, touch sensor controller 12 then communicates information about the touch or proximity input to one or more other components (such as one or more central processing units (CPUs)) of a device that includes touch sensor array 10 and touch sensor controller 12, which may respond to the touch or proximity input by initiating a function of the device (or an application running on the device). Although this disclosure describes a particular touch sensor controller having particular functionality with respect to a particular device and a particular touch sensor, this disclosure contemplates any other touch sensor controllers having any functionality with respect to any device and any touch sensor.

In one embodiment, touch sensor controller 12 is implemented as one or more integrated circuits (ICs), such as for example general-purpose microprocessors, microcontrollers, programmable logic devices or arrays, application-specific ICs (ASICs). Touch sensor controller 12 comprises any combination of analog circuitry, digital logic, and digital non-volatile memory. In one embodiment, touch sensor controller 12 is disposed on a flexible printed circuit (FPC) bonded to the substrate of touch sensor array 10, as described below. The FPC may be active or passive. In one embodiment, multiple touch sensor controllers 12 are disposed on the FPC.

In an example implementation, touch sensor controller 12 includes a processor unit, a drive unit, a sense unit, and a storage unit. In such an implementation, the drive unit supplies drive signals to the drive electrodes of touch sensor array 10, and the sense unit senses charge at the capacitive nodes of touch sensor array 10 and provides measurement signals to the processor unit representing capacitances at the capacitive nodes. The processor unit controls the supply of drive signals to the drive electrodes by the drive unit and process measurement signals from the sense unit to detect and process the presence and position of a touch or proximity input within touch-sensitive areas of touch sensor array 10. The processor unit may also track changes in the position of a touch or proximity input within touch-sensitive areas of touch sensor array 10. The storage unit stores programming for execution by the processor unit, including programming for controlling the drive unit to supply drive signals to the drive electrodes, programming for processing measurement signals from the sense unit, and other programming. Although this disclosure describes a particular touch sensor controller having a particular implementation with particular components, this disclosure contemplates touch sensor controller having other implementations with other components.

Tracks 14 of conductive material disposed on the substrate of touch sensor array 10 couple the drive or sense electrodes of touch sensor array 10 to connection pads 16, also disposed on the substrate of touch sensor array 10. As described below, connection pads 16 facilitate coupling of tracks 14 to touch sensor controller 12. Tracks 14 may extend into or around (e.g., at the edges of) touch-sensitive areas of touch sensor array 10. In one embodiment, particular tracks 14 provide drive connections for coupling touch sensor controller 12 to drive electrodes of touch sensor array 10, through which the drive unit of touch sensor controller 12 supplies drive signals to the drive electrodes, and other tracks 14 provide sense connections for coupling touch sensor controller 12 to sense electrodes of touch sensor array 10, through which the sense unit of touch sensor controller 12 senses charge at the capacitive nodes of touch sensor array 10.

Tracks 14 are be made of fine lines of metal or other conductive material. For example, the conductive material of tracks 14 may be copper or copper-based and have a width of approximately 100 μm or less. As another example, the conductive material of tracks 14 may be silver or silver-based and have a width of approximately 100 μm or less. In one embodiment, tracks 14 are made of ITO in whole or in part in addition or as an alternative to the fine lines of metal or other conductive material. Although this disclosure describes particular tracks made of particular materials with particular widths, this disclosure contemplates tracks made of other materials and/or other widths. In addition to tracks 14, touch sensor array 10 may include one or more ground lines terminating at a ground connector (which may be a connection pad 16) at an edge of the substrate of touch sensor array 10 (similar to tracks 14).

Connection pads 16 may be located along one or more edges of the substrate, outside touch-sensitive areas of touch sensor array 10. As described above, touch sensor controller 12 may be on an FPC. Connection pads 16 may be made of the same material as tracks 14 and may be bonded to the FPC using an anisotropic conductive film (ACF). In one embodiment, connection 18 include conductive lines on the FPC coupling touch sensor controller 12 to connection pads 16, in turn coupling touch sensor controller 12 to tracks 14 and to the drive or sense electrodes of touch sensor array 10. In another embodiment, connection pads 16 are connected to an electro-mechanical connector (such as a zero insertion force wire-to-board connector); in this embodiment, connection 18 may not include an FPC, if desired. This disclosure contemplates any connection 18 between touch sensor controller 12 and touch sensor array 10.

FIG. 1B illustrates an example mechanical stack 30 for a touch sensor 10, according to an embodiment of the present disclosure. In the example embodiment of FIG. 1B, the mechanical stack 30 comprises multiple layers and is illustrated as positioned with respect to a z-axis. The example mechanical stack 30 comprises a display module 28, a driving layer 26, a spacer layer 24, a sensing layer 22, and a cover layer 20. The driving layer 26 and sensing layer 22 comprise drive and sense electrodes, respectively, as discussed above in connection with FIG. 1A. Spacer layer 54 comprises a material which electrically isolates the driving and sensing layers. The display module 28 provides display information to be viewed by a user. The cover layer may be clear and made of a resilient material for repeated touching, such as for example glass, polycarbonate, or poly(methyl methacrylate) (PMMA). A user may interact with touch sensor 10 by touching cover layer 20 using a finger or some other touch object (such as a stylus). A user may also interact with touch sensor 10 by hovering a finger or some other touch object over cover layer 20 without actually making physical contact with cover layer 20. Other embodiments of mechanical stack 30 may implement other configurations, relations, and perspectives, as well as fewer or additional layers.

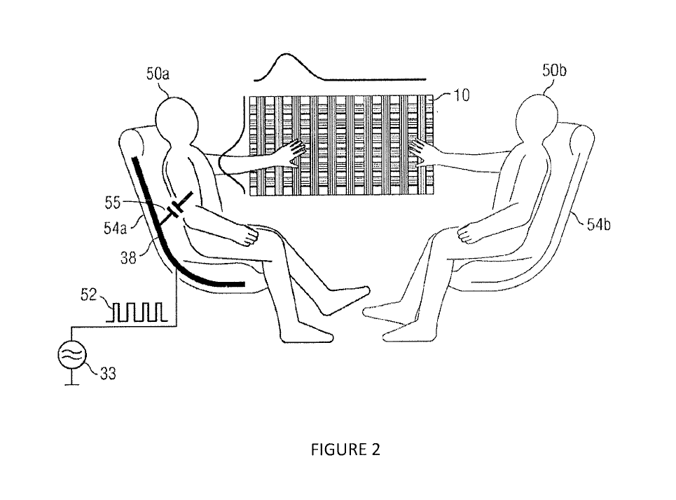

FIG. 2 illustrates an example implementation of touch sensor 10, according to an embodiment of the present disclosure. In the illustrated embodiment, one or more users 50 are each sitting in a respective chair 54 and are each able to interact, possibly simultaneously, with touch sensor 10 (e.g. using a body part or a tool, such as a stylus). In one embodiment, touch sensor 10 is accessible to users 50 located in a room (e.g. lounge, restaurant, waiting room, conference room, command and control center, etc.), a vehicle (e.g. car, train, bus, subway car, boat, airplane, etc.), or at any other location. If touch sensor 10 is located in a vehicle, for example, users 50 can interact with touch sensor 10 regardless of whether the vehicle is in motion or at rest.

Each chair 54 generally refers to any device that can be physically coupled to a user 50. Although in the illustrated example chair 54 is a seat having a surface designed to physically accommodate a substantial portion of the body of user 50a, an alternative embodiment uses a smaller device in place of chair 54, such as, for example, a wristwatch or a stylus.

In the example of FIG. 2, chair 54a supporting user 50a includes embedded source electrode 38, while chair 54b supporting user 50b includes no embedded source electrode. In an alternative embodiment, chair 54b also includes one or more similar source electrodes 38. In addition, either or both chairs 54 may include multiple embedded source electrodes, rather than a single embedded source electrode as illustrated. Although FIG. 2 shows that each user 50 is seated in a respective chair 54, in an alternative embodiment several users 50 can be capacitively coupled to the same source electrode 38.

In the preferred embodiment, source electrodes 38 are made from flexible conductive material, such as, for example, conductive rubber, metal wire, carbon fibers, or other flexible conductive material. In an alternative embodiment, however, electrodes 38 can be made from conductive material that does not readily bend or flex. For example, electrodes 38 can each include a solid conductive plate. Certain source electrodes 38 are configured to have a resistance that is substantially less than 20 to 40 kOhms. Particular source electrodes 38 can have little to virtually no resistance.

In one embodiment, source electrode 38 is at least partially covered with a dielectric material (e.g. soft foam, cotton, etc.). In certain instances, one or more dielectric materials are used that have a higher dielectric constant, which increases the equivalent dielectric constant of the dielectric material and thus increases the signal injected into measuring electrode 22. To increase the dielectric constant of the material(s) used, in certain instances, small conductive particles (e.g. metal dust, metal flakes, etc.) are added to the dielectric material(s) (e.g. in close proximity to source electrode 38).

Generally, the capacitive coupling 55 between each source electrode 38 and its respective user 50 is directly related to the size of the source electrode 38 and inversely related to the distance between the source electrode 38 and its user 50. For example, increasing the size of source electrode 38 increases the capacitive coupling 55 between the source electrode 38 and the body of a user 50, and thus directly increases the transferred charge between signal source 33 and the measuring electrodes 22 of touch sensor 10. In addition, a thinner dielectric between the source electrode 38 and the body of a user 50 increases the capacitive coupling 55 between the source electrode 38 and the body of a user 50, and thus directly increases the transferred charge between signal source 33 and the measuring electrodes 22 of touch sensor 10. A higher voltage applied to source electrode 38 by signal source 33 also directly increases the transferred charge between signal source 33 and the measuring electrodes 22 of touch sensor 10. For example, high voltage drivers can be used to increase the amplitude on the signal source electrodes 38. In certain vehicle implementations, each source electrode 38 is well insulated from the vehicle chassis and from other electric circuits.

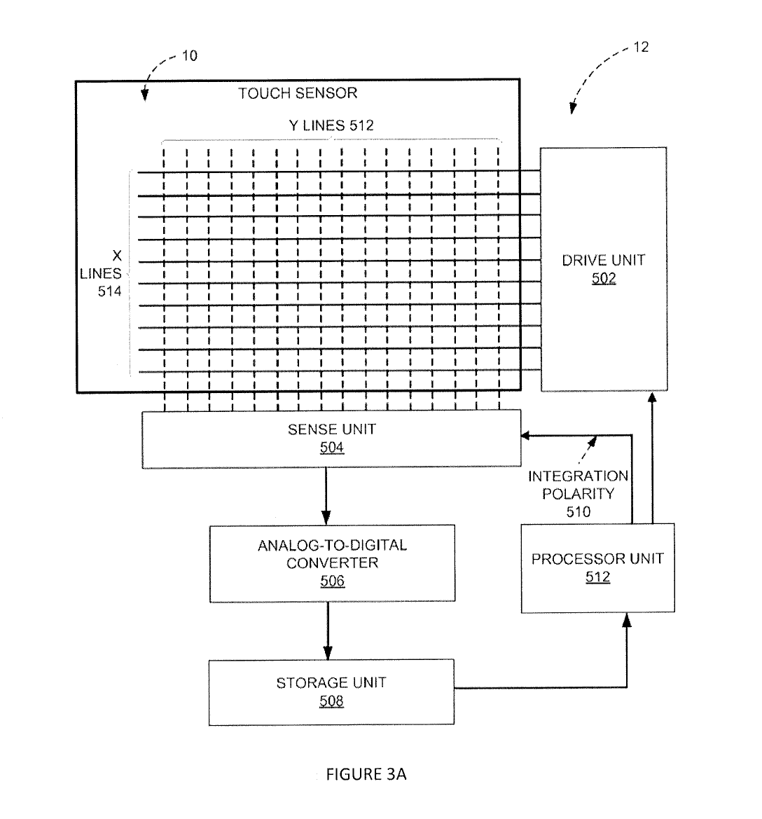

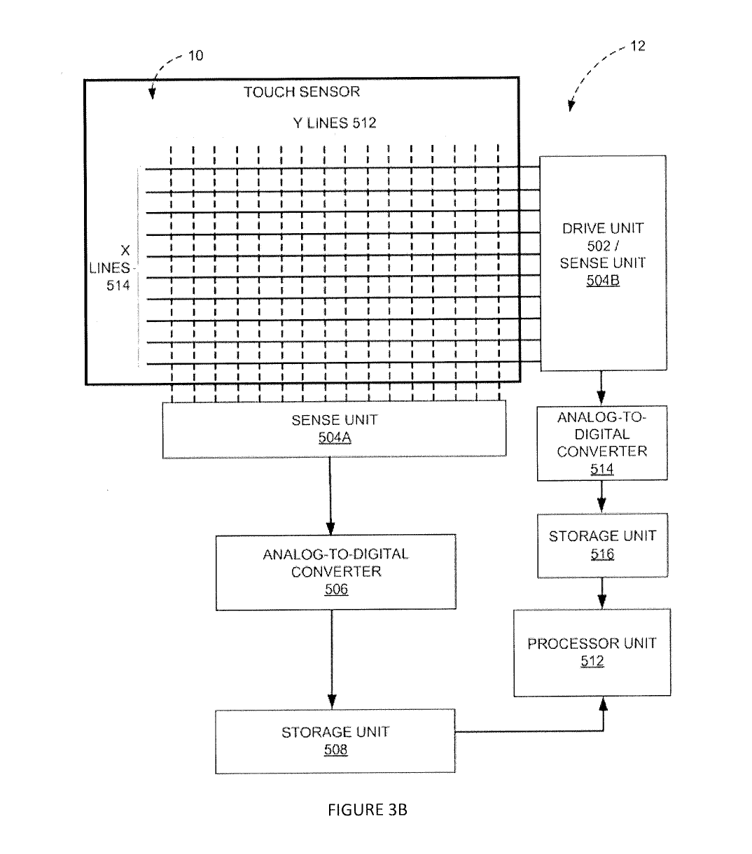

In operation, certain signals 52 are provided from signal source 33 to touch sensor 10 through a touch object 26, such as through the body of each user 50, when the touch object 26 is electrically coupled to the touch sensor 10, allowing the signals 52 to electrically couple to the touch sensor 10. For purposes of an embodiment of this description, an object (e.g., a finger or stylus) being electrically coupled to a touch sensor includes an object (e.g., a finger or a stylus) that is physically touching a touch screen within a touch-sensitive area of a touch sensor of the touch screen (e.g., by physically touching a cover layer overlaying a touch sensor array of the touch sensor, as described above in connection with FIGS. 1A-1B) or that is sufficiently close to the touch sensor to allow signals 52 to be detected on the electrodes of the touch sensor (e.g., by hovering above the cover layer overlaying the touch sensor array of the touch sensor, as described above in connection with FIGS. 1A-1B). In one embodiment, the signals 52 may capacitively couple to touch sensor 10 through the touch object 26. In an alternative embodiment, the signals 52 may galvanically couple to touch sensor 10 through the touch object 26. The provision of signals through each user 50 from signal source 33 facilitates distinguishing one touch object from another, as explained further below with reference to FIG. 3B. In one embodiment, touch sensor 10 (or a controller thereof, such as controller 12) controls the provision of signals to source electrodes 38 by signal source 33. Particular touch sensors 10 may include one or more signal sources 33.

In the example of FIG. 2, signal 52 generated by signal source 33 is a sinusoidal waveform having relatively low frequency and relatively high voltage. For example, signal 52 may have a frequency of approximately 16 KHz and a voltage of between approximately 10 and 30 Volts. In another embodiment, signal 52 may be any other smooth waveform, or a waveform having one or more dominant frequency components. Dominant frequency components may refer to frequency components above a predetermined threshold when a frequency sensitive algorithm is applied. As an example and not by way of limitation, the signal 52 can be any smooth wave whose instantaneous rate of change of voltage over time is substantially within predetermined limits.

During a touch-detection mode of operation, touch sensor 10 performs processing to suppress injected signal 52 that may be present on the electrodes of touch sensor 10 when user 50a is touching touch sensor 10. As a result, in the preferred embodiment, signal sources 33 need not be configured to provide signals synchronized with a controller of touch sensor 10. In other words, signal sources 33 can operate asynchronously from the operations of touch sensor 10 and touch controller 12, and can supply signal 52 to source electrode 38 without regard to whether touch sensor 10 is operating in touch-detection mode or source-identification mode. The touch-detection mode of operation is described in more detail in connection with FIG. 3A.

During a source-identification mode of operation, touch sensor 10 can detect whether a user 50 who touched an active area of touch sensor 10 is seated in his or her chair 54. In particular, touch sensor 10 can detect the presence of injected signal 52 on the electrodes of touch sensor 10 around the area of a detected touch. In the example of FIG. 2, where injected signal 52 is present, touch sensor 10 can associate the touch with user 50a, but where injected signal 52 is not present, touch sensor 10 can associate the touch with user 50b. The source-identification mode of operation is described in more detail in connection with FIG. 3B. Touch sensor 10 may, in one embodiment, select an action from a predetermined set of actions based on whether injected signal 52 is present. For example, touch sensor 10 may disregard a touch that occurs when injected signal 52 is present. Touch sensor 10 may, in one embodiment, selectively enable or disable certain commands based on a determination regarding whether one or more users 50 are not capacitively coupled to their respective source electrodes 38 in chair 54, which may enhance the safety of the user 50 in particular applications. For example, in an automotive application, touch sensor 10 may only accept commands from the person in the passenger seat, but not the driver seat, during times when the vehicle is in motion or travelling above a certain speed.

FIG. 3A illustrates an example touch sensor 10 and touch-sensor controller 12 configured for a touch-detection mode of operation, according to an embodiment of the present disclosure. In the illustrated embodiment, touch sensor controller 12 includes touch sensor 10, drive unit 502, sense unit 504, analog-to-digital converter (ADC) 506, storage unit 508, and processor unit 512. Touch sensor 10 includes a plurality of X lines 514 and a plurality of Y lines 512. X lines 514 form the drive electrode lines of touch sensor 10 as described above. Herein, reference to X lines 514 encompasses drive electrode lines, and vice versa, where appropriate. Similarly, Y lines 512 form the corresponding sense electrode lines of touch sensor 10 as described above. Herein, reference to Y lines 512 encompasses sense electrode lines, and vice versa, where appropriate.

In the illustrated embodiment, touch controller 12 is configured to provide an interaction between touch sensor 10 and users 50. Processor unit 512 is configured to measure signals present on Y lines 512. In one embodiment, such signals are sense signals that are initiated by drive signals being applied to the corresponding X lines 514 by drive unit 502. Such drive signals generate electric field extending from the X lines 514 to the corresponding Y lines 512. Accordingly, the electric field may produce corresponding sense signals in the Y lines 512. As an example and not by way of limitation, when drive unit 502 applies a rising voltage signal (for example, a voltage signal that transitions from a logic-low voltage to a logic-high voltage) to one of X lines 514, a positive spike of sense signal is generated on a corresponding sense electrode line of Y lines 512. As another example and not by way of limitation, when drive unit 502 applies a falling voltage signal (for example, a voltage signal that transitions from a logic-high voltage to a logic-low voltage) to one of X lines 514, a negative spike of sense signal is generated on a corresponding sense electrode line of Y lines 512.

In one embodiment, touch-sensor controller 12 sequentially pulses X lines 514 and measures the response received over Y lines 512. Accordingly, touch-sensor controller 12, utilizing mutual-capacitance measurements, produces a two-dimensional array of measured sense signals where each cell of the two-dimensional array represents a measured capacitance between corresponding X line 514 and Y line 512 of touch sensor 10. In an embodiment, touch-sensor controller 12 may determine a position of any touch object within proximity of touch sensor 10 by processing data of the two-dimensional array. Herein, reference to a touch object encompasses any object that causes a detectable change in mutual-capacitance and/or a self-capacitance of one or more electrodes of a touch sensor, such as a finger or a stylus.

Although this disclosure describes and illustrates particular components of particular touch-sensor controller for performing capacitance measurements in particular manner, this disclosure contemplates any combination of one or more components of any touch-sensor controller for performing capacitance measurements in any manner. As an example and not by way of limitation, touch-sensor controller 12 and touch sensor 10 may alternatively implement self-capacitance measurement.

In certain circumstances, signals present on Y lines 512 may be initiated by a third-party sinusoid electrical signal. The third-party sinusoid electrical signals may oscillate at a frequency that is substantially lower than the acquisition frequency utilized by sense unit 504 to acquire signals from Y lines 512. As an example and not by way of limitation, an acquisition frequency of sense unit 504 may substantially be between 100 kHz and 120 kHz. As an example and not by way of limitation, the third-party sinusoid electrical signal may be power-line noise of low-frequency (for example, 50 Hz to 60 Hz) and high-voltage (for example, above 200V). As another example and not by way of limitation, the third-party sinusoid electrical signal may be injected signal 52 generated by signal source 33 of FIG. 2, coupled to the electrodes via the touch object.

In the preferred embodiment, injected signal 52 operates at a frequency that is higher than frequency of the power-line noise (as described above) and lower than acquisition frequency of sense unit 504. As an example and not by way of limitation, the low-frequency electrical oscillating signal may operate at a frequency that is approximately 16 kHz while the acquisition frequency of sense unit 504 may be between approximately 100 kHz and approximately 120 kHz. As another example and not by way of limitation, the acquisition frequency of sense unit 504 may be approximately five to eight times a frequency of the low-frequency electrical oscillating signal.

When voltage amplitude of the third-party sinusoid electrical signal exceeds 200V, the charge injected by the third-party sinusoid electrical signal into touch sensor 10 can potentially envelop the real sense signals produced by Y lines 512. As such, the accuracy of measurement by touch-sensor controller 12 may be affected. Even when voltage amplitude of the third-party sinusoid electrical signal is only relatively high (for example, 20V to 40V), the charge injected into touch sensor 10 may be substantially higher than any normal environmental noise captured by touch sensor 10. In other words, the third-party sinusoid electrical signal may have a substantial signal footprint, even in the presence of environmental noise.

Nevertheless, when frequency of the third-party sinusoid electrical signal is substantially lower than the acquisition frequency of sense unit 504, the third-party sinusoid electrical signal should not substantially affect the measurement accuracy and performance of the touch-sensor controller 12. As an example and not by way of limitation, linearity and position jitter as associated with touch and proximity measurements by touch-sensor controller 12 remain substantially unchanged. As such, touch-sensor controller 12 may continue to detect and measure the proximity of any objects substantially close to touch sensor 10, even in the presence of one or more high-voltage and low-frequency third-party sinusoid electrical signals.

However, the third-party sinusoid electrical signals may further modulate signals on Y lines 512 as the signals are being acquired by sense unit 504. In an embodiment, the extent of modulation depends at least on the amount of charge being transferred from the power-line and/or signal 52, the time at which the signals on Y lines 512 are being acquired by sense unit 504, and the duration of acquisition.

To reduce or eliminate the impact of third-party sinusoid electrical signals on touch detection, controller 12 is configured to perform processing to suppress the third-party sinusoid electrical signals from the measured signals on Y lines 512. In the preferred embodiment, processor unit 512 includes logic to perform dual measurements, reversing the polarity of sense signals acquired between the first and second measurements. As an example of dual-measurement in the digital domain and not by way of limitation, processor unit 512 configures sense unit 504 to acquire signals from Y lines 512 of touch sensor 10 at a first time instance and at a second time instance that immediately succeeds the first time instance. The second time instance is substantially close to the first time instance such that overall acquisition frequency of sense unit 504 is substantially higher than the frequency of any third-party sinusoid electrical signal as described above. In addition, processor unit 512 configures sense unit 504 to reverse the polarity of the acquired signal at the second time instance. In the example of FIG. 3A, sense unit 504 receives an indication from processor unit 512 via integration polarity 510 whether to reverse polarity of a sense signal as acquired by sense unit 504 at a particular time. For example, sense unit 504 acquires first sense signal S at time instance t₀₀ when integration polarity 510 is positive. Sense unit 504 then acquires sense signal −S at time instance t₁₀ when integration polarity 510 is negative. Although this disclosure describes and illustrates particular touch-sensor controller measuring particular sense signals of particular touch sensor by utilizing particular components in a particular manner, this disclosure contemplates the touch-sensor controller measuring any sense signals of the touch sensor by utilizing one or more of any component in any manner.

Next, processor unit 512 retrieves both normal (a.k.a. acquired signal at first time instance) measured signal and inverted (a.k.a. acquired signal at second time instance whose polarity has been reversed) measured signal from storage unit 508 and applies one or more post-processing algorithms to both signals. As an example of a post-processing algorithm and not by way of limitation, processor unit 512 may digitally add both normal and inverted measured signals. As another example of a post-processing algorithm and not by way of limitation, processor unit 512 may digitally subtract the inverted measured signal from the normal measured signal.

Although this disclosure describes and illustrates particular components of particular touch-sensor controller for performing dual-measurement in particular manner, this disclosure contemplates any combination of one or more components of any touch-sensor controller for performing dual-measurement in any manner. As an example and not by way of limitation, dual-measurement can alternatively be performed in the analog domain. Accordingly, sense unit 504 can include one or more integrator circuits for acquiring signals from touch sensor 10. In addition, sense unit 504 can reverse the polarity of signal as acquired during second time instance by reversing the polarity of the integrator circuit associated with the acquisition of the signal. Furthermore, the post-processing algorithms as described above may be performed by utilizing one or more integrator circuits and changing the polarity of one or more integrator circuits. As an alternate means for reversing polarity of acquired signals in the analog domain, sense unit 504 can measure sense signals in response to positive and negative edges of drive signals as applied by drive unit 502 to one or more corresponding X lines 514 of touch sensor 10.

In one embodiment, touch-sensor controller 12 includes an ADC 506 to convert analog signals as received from sense unit 504 into corresponding digital signals. The digital units may be stored in storage unit 508 for further post-processing by at least processor unit 512. In the example of FIG. 3A, storage unit 508 may a store digital form of actual-measured signal S+N1 as measured from sense unit 504 at time instance t₀₀ and store digital form of actual-measured signal −S+N2 as measured from sense unit 504 at time instance t₁₀ for further processing by processor unit 512. In one embodiment, storage unit 508 includes a random access memory (RAM) or other storage element for storing the normal (for example, sense signal S) and reversed (for example, sense signal −S) measured signals. Although this disclosure describes and illustrates particular components for storing signals as acquired from particular touch sensor in digital domain, this disclosure contemplates any combination of one or more components for storing signals as acquired from the touch sensor in any manner. As an example and not by way of limitation, the signals as acquired from touch sensor 10 can be stored in internal capacitors residing within touch-sensor controller 12. Furthermore, although this disclosure describes and illustrates particular storage unit, the disclosure contemplates any storage unit.

In one embodiment, processor unit 512 also includes logic to perform a single measurement. As an example of a single measurement in the digital domain and not by way of limitation, processor unit 512 may configure sense unit 504 to acquire signals from Y lines 512 of touch sensor 10 at the first time instance and at the second time instance. In this case, in contrast to dual measurement, polarity of the acquired signal at the second time instance is not reversed by processor unit 512. Next, processor unit 512 retrieves both measured signals as acquired from storage unit 508 and applies one or more post-processing algorithms to both signals. As an example of a post-processing algorithm and not by way of limitation, processor unit 512 may digitally apply one or more Fourier synthesis to at least both measured signals to detect and retrieve any single tone frequency as embedded within the measured signals. Although this disclosure describes and illustrates particular components of particular touch-sensor controller for performing single-measurement in particular manner, this disclosure contemplates any combination of one or more components of any touch-sensor controller for performing single-measurement in any manner.

FIG. 3B illustrates touch sensor 10 and touch-sensor controller 12 of device 42 configured for a source-identification mode of operation, according to an embodiment of the present disclosure. In the example of FIG. 6B, touch-sensor controller 12 includes touch sensor 10, drive unit 502 (or sense unit 504B), sense unit 504A, ADC 506, ADC 514, storage unit 508, storage unit 516, and processor unit 512. During the source-identification mode of operation, touch controller 12 is configured to detect, rather than suppress, injected signal 52, which is then used to identify the source of the touch object.

In the example of FIG. 3B, touch sensor 10 is dedicated to receiving injected signal 52 generated by signal source 33. Accordingly, touch-sensor controller 12 configures X lines 514 (in addition to Y lines 512) to sense injected signal 52 generated by signal source 33. Furthermore, touch-sensor controller 12 configures drive unit 502 to acquire signals from X lines 514. As an example and not by way of limitation, touch-sensor controller 12 configures drive unit 502 as sense unit 504B to acquire signals from X Lines 514. As such, X lines 514 and Y lines 512 of touch sensor 10 become sense electrode lines dedicated for acquiring the signals from touch sensor 10.

In the illustrated embodiment, in addition to configuring drive unit 502 as sense unit 504B to acquire signals from X lines 514, touch-sensor controller 12 utilizes ADC 514 to convert the signals acquired from X lines 514 and Y lines 512 to digital samples. Furthermore, touch-sensor controller 12 temporarily stores the digital samples using storage unit 516 before sending them for further post-processing by processor unit 512.

Processor unit 512 processes the captured samples to determine whether the injected signal 52 is present. In the preferred embodiment, processor unit 512 applies a frequency sensitive algorithm (for example, Goertzel algorithm) to determine one or more frequency components (for example, frequency tones) and their associated strengths (for example, amplitudes) of the individual ADC samples along a first coordinate axis (for example, X axis) corresponding to X lines 514 and a second coordinate axis (for example, Y axis) corresponding to Y lines 512. In an alternative embodiment, touch-sensor controller 12 may only sample and determine frequency components along one coordinate axis (e.g., a single X line 514 or Y line 512). For example, touch-sensor controller 12 might only measure the signal on a single electrode located near the touch location determined during the touch-detection mode of operation.

As discussed above, injected signal 52 is a predetermined waveform (such as a sinusoid) having a known frequency or known frequency components (such as 16 KHz). By analyzing data corresponding to the frequency components and their associated strengths along the first and second coordinate axis, touch-sensor controller 12 detects whether injected signal 52 is present at a given location on the touch sensor 10 (such as at the location of a detected touch). For example, controller 12 can apply a detection threshold to each calculated strength to determine whether signal 52 is present at each location. If signal 52 is determined to be present at the location of a detected touch object, controller 12 can identify the source of the touch object as being associated with the source electrode 38 (e.g., person 50a in seat 54a in the example of FIG. 2). Conversely, if signal 52 is determined not to be present at the location of a detected touch object, controller 12 can identify the source of the touch object as not being associated with the source electrode 38 (e.g., person 50b in seat 54b in the example of FIG. 2). By spatially associating the calculated data from the source-identification mode with the touch data from the touch-detection mode in this manner, controller 12 can identify the source of each touch object even if there are multiple simultaneous touches.

In one embodiment, touch-sensor controller 12 may not have adequate computing resources to simultaneously measure all X lines 514 and Y lines 512. For example, a memory capacity of storage unit 508 and/or storage unit 516 might be inadequate to process all the measurements retrieved from X lines 514 and Y lines 512 in one pass. Accordingly, touch-sensor controller 12 may sequentially measure groups of X lines 514 and Y lines 512 in one or more passes.

In an alternative embodiment, the source-identification measurement is performed with a lower spatial resolution to speed up the measurement process and/or to conserve computational resources. For example, rather than acquiring and storing signals from every X line 514 and Y line 512, controller 12 may only acquire and store signals from every other X line 514 and/or Y line 512 (e.g. only odd or only even lines). As another example, multiple electrodes (X lines or Y lines) can be galvanically or capacitively connected to form clusters of electrodes, with signals acquired from each cluster. For instance, 12 X lines 514 could be divided into 4 clusters of 3 electrodes each.

Although this disclosure describes and illustrates particular source-identification measurements, the disclosure contemplates any source-identification measurements in any manner. Moreover, although this disclosure describes and illustrates particular components of touch-sensor controller 12 for source-identification measurements, the disclosure contemplates any combination of one or more of any component of touch-sensor controller 12 for source-identification measurements in any manner.

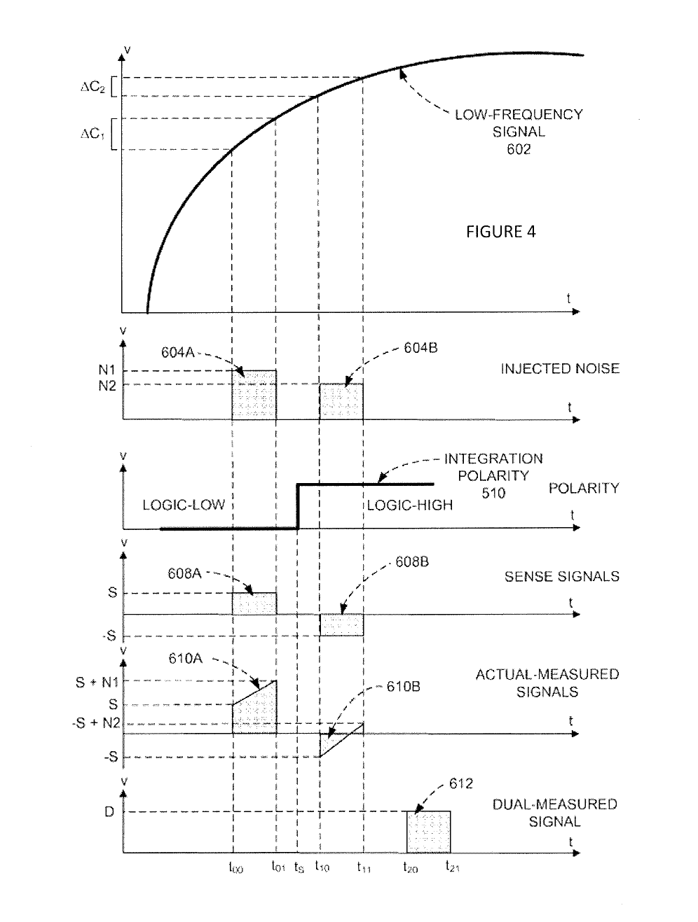

FIG. 4 (not necessarily shown to scale) illustrates example signals of touch-sensor controller 12 during an example dual-measurement cycle, according to an embodiment of the present disclosure. In the example of FIG. 4, low-frequency signal 602 is generated by signal source 33 and injected onto touch sensor 10 via a touch object that capacitively and/or galvanically coupled to source electrode 38. In one embodiment, low-frequency signal 602 could be a third-party sinusoid electrical signal of high-voltage and low-frequency, as described above, such as interference from a power supply or other environmental sources.

At time instance t₀₀, sense unit 504 is configured by processor unit 512 to acquire from one of Y lines 512 sense signal 608A of magnitude S as illustrated in FIG. 4. In the example mutual-capacitance implementation described above, sense signal 608A is produced at least in part by drive signal being applied by drive unit 502 to one or more corresponding X lines 514 of touch sensor 10. During the period of acquisition (for example, period t₀₀-t₀₁ as illustrated in FIG. 4), signal 602 changes. The magnitude delta of ΔC₁ with low-frequency signal 602 produces injected signal 604A of magnitude N1 that is acquired by sense unit 504 during acquisition period t₀₀-t₀₁. As such, an actual-measured signal 610A of magnitude S+N1 is measured by sense unit 504 at time instance t₀₁. In the illustrated embodiment, the acquisition period t₀₀-t₀₁ is substantially smaller than the reciprocal of the acquisition frequency of touch sensor 10. As an example and not by way of limitation, the acquisition period t₀₀-t₀₁ may substantially be between 0.5 μs and 3.0 μs. In one embodiment, a duration of acquisition period t₀₀-t₀₁ depends on the type of low-frequency signal 602. For instance, if low-frequency signal 602 corresponds to an undesirable noise signal, such as a line noise, the duration may be configured by touch-sensor controller 12 to be below a pre-determined threshold duration.

Similarly at time instance t₁₀, sense unit 504 may be configured by processor unit 512 to acquire sense signal from the same sense electrode line (as with earlier acquisition) of touch sensor 10. In one embodiment, time instances t₀₀ and t₁₀ may be determined at least by the frequency at which sense signal is being acquired from touch sensor 10 by sense unit 504. For example, the time difference between time instances t₀₀ and t₁₀ could be between 1.5 μs and 8.0 μs. As another example and not by way of limitation, the time difference between two consecutive acquisitions of the sense signal (for example, time difference between time instances t₀₀ and t₁₀) could be approximately 3 μs to approximately 10 μs.

In addition, sense unit 504 may be configured by processor unit 512 via integration polarity 510 to reverse polarity of the acquired sense signal. In the example of FIG. 4, integration polarity 510 reverses from positive to negative between time instances t₀₁ and t₁₀ (such as for example at time instance tₛ) as an indication to sense unit 504 to reverse polarity of sense signal as acquired at time instance t₁₀. As such, sense unit 504 acquires sense signal 608B of magnitude −S at time instance t₁₀.

As with the earlier acquisition, during the latest period of acquisition (for example, period t₁₀-t₁₁ as illustrated in FIG. 4) signal 602 changes. A magnitude delta of ΔC₂ with low-frequency signal 602 produces injected signal 604B of magnitude N2 that is acquired by sense unit 504 during acquisition period t₁₀-t₁₁. As such, an actual-measured signal 610B of magnitude −S+N2 is measured by sense unit 504 at time instance t₁₁. In the illustrated example, acquisition period t₁₀-t₁₁ is substantially smaller than the reciprocal of the acquisition frequency of touch sensor 10. As with acquisition period t₀₀-t₀₁, the acquisition period t₁₀-t₁₁ may substantially be between 0.5 μs and 3.0 μs.

In one embodiment, the difference in magnitudes N1 and N2 may depend at least on the frequency by which signals are acquired from touch sensor 10 by sense unit 504. In the example of FIG. 4, as the acquisition frequency of sense unit 504 increases, the difference in time between time instance t₀₀ and t₁₀ reduces. When acquisitions of actual-measured signals 610A-610B by sense unit 504 at time instances t₀₀ and t₁₀ are configured to be close to each other, corresponding ΔC₁ and ΔC₂ of low-frequency signal 602 should be substantially similar. Accordingly, magnitude N1 should be substantially similar to magnitude N2. In contrast, when acquisitions of actual-measured signals 610A-610B by sense unit 504 at time instances t₀₀ and t₁₀ are configured to be further apart, corresponding ΔC₁ and ΔC₂ by low-frequency signal 602 could be substantially different. Accordingly, magnitude N2 could be substantially different from magnitude N1. In one embodiment, both magnitudes N1 and N2 have the same polarity. When acquisition frequency of sense unit 504 is substantially higher than that of low-frequency signal 602, polarities of both ΔC₁ and ΔC₂ should be the same. Accordingly, both magnitudes N1 and N2 should have the same polarity.

Although the disclosure describes and illustrates particular injected signals 604A-604B as produced by low-frequency signal 602, the disclosure contemplates any injected signals as produced by any low-frequency signal. Moreover, although this disclosure describes and illustrates particular sense signals 608A-608B as acquired by sense unit 504, the disclosure contemplates any sense signals as acquired by any sense unit.

In the example of FIGS. 3A and 4, processor unit 512 includes logic to retrieve actual-measured signals 610A-610B from storage unit 508 and apply one or more post-processing algorithms to both signals to produce dual-measured signal 612 of magnitude D at time instance t₂₀. As an example of a post-processing algorithm, processor unit 512 digitally adds both actual-measured signals 610A-610B to generate dual-measured signal 612 of magnitude (e.g., D of FIG. 4) N1+N2 at time instance t₂₀. As such, adding both actual-measured signals as described above may suppress any sense signals 608A-608B. Given that sense signals 608A-608B may be utilized by touch-sensor controller 12 to detect and measure one or more touch events that are associated with proximity of any object to touch sensor 10, adding both actual-measured signals as described may be used to suppress the touch events.

As another example of post-processing algorithm, processor unit 512 digitally subtracts actual-measured signal 610B from actual-measured signal 610A to generate dual-measured signal 612 of magnitude (for example, D of FIG. 4) 2S+N1−N2. If magnitudes N1 and N2 are substantially similar, D may substantially approximate 2S. As such, subtracting actual-measured signal 610B from actual-measured signal 610A suppresses the effect of low-frequency signal 602 on touch sensor 10 and effectively doubles sense signal 608A/B. This may make touch-sensor controller 12 more sensitive to sense signals present on Y lines 512. In one embodiment, it may be desirable to suppress the effect of low-frequency signal 602 on actual-measured signals 610A-610B as low-frequency signal 602 may generate noise causing substantial position jitters in the measured proximity of a touch object from touch sensor 10.

Although this disclosure describes and illustrates particular components of particular touch-sensor controller for performing dual-measurement in a particular sequence at particular time instances, the disclosure contemplates any combination of one or more components of any touch-sensor controller performing dual-measurement in any order and at any time instances. Furthermore, although this disclosure describes and illustrates particular waveforms and signals for dual-measurement by particular touch-sensor controller in particular order and in particular manner, this disclosure contemplates any combination of one or more of a waveform and one or more of a signal for dual-measurement by any touch-sensor controller in any order and in any manner.

In one embodiment, touch sensor 10 utilizes self-capacitance measurements. Thus, at time instances t₀₀ and t₀₁, touch-sensor controller 12 acquires sense signals 608A and 608B via drive unit 502 and/or sense unit 504. Drive unit 502 and/or sense unit 504 measures and acquires sense signals 608A and 608B from corresponding X lines 514 and/or Y lines 512 via self-capacitance measurements. During both periods of acquisitions (i.e., t₀₀-t₀₁ and t₁₀-t₁₁), sense signals 608A-608B may be modulated by low-frequency signal 602 as described above. Furthermore, sense signal 608B is inverted by associated drive unit 502 or sense unit 504 as described above. Processor unit 512 digitally adds both actual-measured signals 610A and 610B to suppress touch signals (i.e., sense signals 608A-608B) and retrieve signals N1 and N2 injected by low-frequency signal 602. Alternatively, assuming magnitudes of injected signals N1 and N2 are approximately equivalent, processor unit 512 digitally subtracts actual-measured signals 610B from actual-measured 610A to suppress signals N1 and N2 injected by low-frequency signal 602 and retrieve the touch signals (i.e., sense signals 608A-608B). As such, it may be desirable to suppress the effect of low-frequency signal 602 on actual-measured signals 610A-610B as low-frequency signal 602 may generate noise causing substantial position jitters in the measured proximity of a touch object from touch sensor 10 due to the retrieved touch signals. Although this disclosure describes particular dual-measurement cycle based on particular self-capacitance measurement, the disclosure contemplates any dual-measurement cycle based on any self-capacitance measurement in any manner.

In another embodiment, sense signals 608A-608B represent an injected signal generated by signal source 33 rather than touch events associated with other capacitive objects to touch sensor 10, as described above. Furthermore, low-frequency signal 602 represents third-party noise. Sense signals 608A-608B are acquired by touch-sensor controller 12 of FIG. 3B based at least on source-identification measurements. Furthermore, during both periods of acquisitions (i.e., t₀₀-t₀₁ and t₁₀-t₁₁), sense signals 608A-608B are modulated by the third-party noise. As an example and not by way of limitation, the third-party noise may include line noise (approximately 50 Hz to approximately 60 Hz). Accordingly, assuming magnitudes of injected signals N1 and N2 (due to the third-party noise) are approximately equivalent, processor unit 512 digitally subtracts actual-measured signals 610B from actual-measured 610A to suppress signals N1 and N2 injected by the third-party noise and retrieve the sense signals (i.e., sense signals 608A-608B) generated by signal source 33. As such, it is desirable to suppress the effect of the third-party noise on actual-measured signals 610A-610B.

Furthermore, processor unit 512 applies one or more frequency sensitive algorithms (for example, Goertzel and/or FFT algorithms) to determine one or more frequency components (for example, frequency tones) and their associated strengths (for example, amplitudes) from the sense signals 608A-608B to identify the source of the touch object, as described above in connection with FIG. 3B. Furthermore, frequency sensitive algorithms may further substantially remove third-party noise having out-of-band frequencies and/or pre-determined frequencies that could cause aliasing on the desired stylus signals.

In one embodiment, touch-sensor controller 12 is configured to increase immunity against third-party noise. For instance, touch-sensor controller 12 can be configured to increase an acquisition frequency of sense unit 504. In an embodiment, an increase in the number of measured acquired digital samples allows touch-sensor controller 12 to substantially improve a differentiation of the sense signals (e.g., touch signals and/or injected signals generated by signal source 33) from third-party noise. As another example, touch-sensor controller 12 can further utilize one or more digital filtering techniques, such as median filtering and averaging, to suppress third-party noise. As yet another example, touch-sensor controller 12 can ensure that one or more of the integrator circuits in sense unit 504 do not saturate, a situation which would make it substantially more difficult for touch-sensor controller 12 to remove third-party noise. Although this disclosure describes particular examples of increasing noise immunity, the disclosure contemplates increasing noise immunity by any touch-sensor controller in any manner.

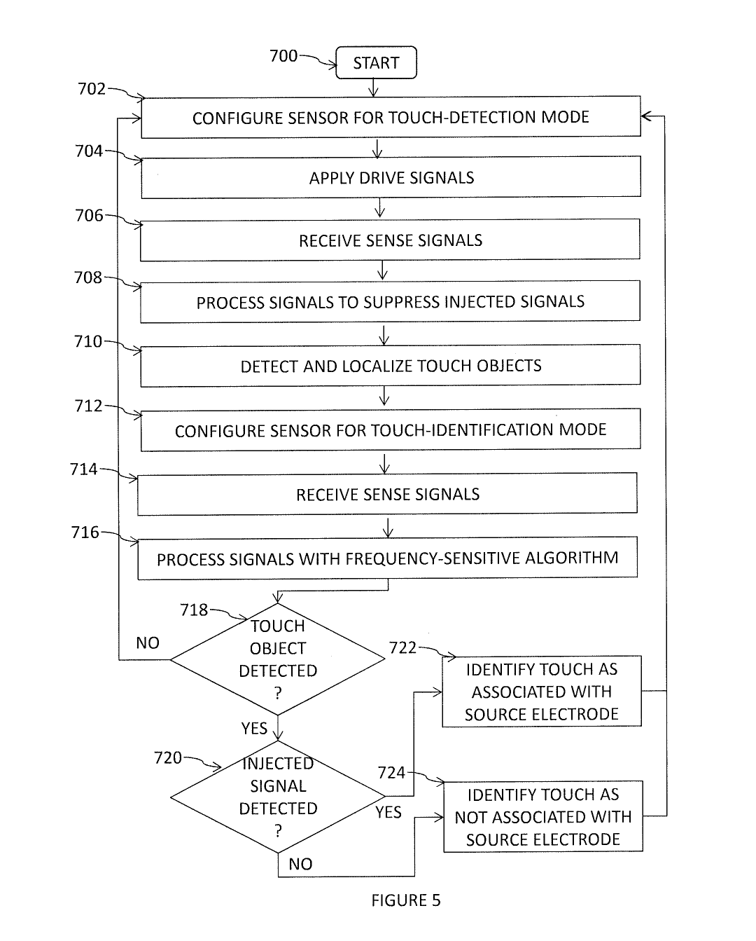

FIG. 5 illustrates an example method 700 for touch detection and source identification using touch-sensor controller 12, according to an embodiment of the present disclosure. Method 700 starts at step 702, where touch sensor 10 and/or touch controller 12 are configured for a touch-detection mode of operation, as described in connection with FIG. 3A. At step 704, drive signals are applied to touch sensor 10 associated with touch-sensor controller 12 of FIG. 3A. One or more drive signals are applied to one or more drive electrode lines of X lines 514 in touch sensor 10. In the example of FIG. 3A, one or more drive signals are applied to each drive electrode line of X lines 514 in a particular sequence and at particular time instances. Each electrode of the drive electrode line can be configured by the drive signals to generate electric field that projects upwards and outwards from the electrode. Accordingly, the generated field may reach one or more neighboring sense electrode lines of Y lines 512.

At step 706, sense signals are received from touch sensor 10. One or more sense signals are received from each sense electrode line of Y lines 512. The sense signals are produced in part by the electric field. Furthermore, the sense signals indicate whether at least one touch object has come within proximity of touch sensor 10. In the preferred embodiment, the sense signals are acquired using dual successive measurements with polarity reversed between them as described above. At step 708, controller 12 processes the acquired sense signals to suppress injected signals, such as signal 52 generated by signal source 33. For example, controller 12 digitally subtracts two successive measurements, as described above in connection with FIGS. 3A and 4. At step 710, controller 12 detects and localizes any touch objects based on the acquired sense signals. Controller 12 determines whether any touch objects are present proximate the active area of the touch sensor, and if so, determines the location of each such touch object.

At step 712, touch sensor 10 and/or touch controller 12 are configured for a source-identification mode of operation, as described above in connection with FIG. 3B. X lines 514 and Y lines 512 of touch sensor 10 become sense electrode lines dedicated for acquiring the signals from touch sensor 10. At step 714, sense signals are received from touch sensor 10. The signals acquired from X lines 514 and Y lines 512 are converted to digital samples. At step 716, the sampled signals are processed with a frequency-sensitive algorithm (for example, Goertzel algorithm) to determine one or more frequency components and their associated strengths along a first coordinate axis (for example, X axis) corresponding to X lines 514 and a second coordinate axis (for example, Y axis) corresponding to Y lines 512.

At step 718, touch controller determines whether there were any touch objects detected for which the source should be identified. If not, the method returns to step 702, where the touch sensor 10 and touch controller 12 are once again configured for a touch-detection mode of operation. If so, the method continues to step 720. At step 720, touch controller 12 determines whether injected signal 52 is detected at the location of the detected touch object. For example, controller 12 can apply a detection threshold to each calculated strength to determine whether signal 52 is present at each location. If signal 52 is determined to be present at the location of a detected touch object, the method proceeds to step 722, where controller 12 identifies the source of the touch object as being associated with the source electrode 38 (e.g., person 50a in seat 54a in the example of FIG. 2). Conversely, if signal 52 is determined not to be present at the location of a detected touch object, the method proceeds to step 724, where controller 12 identifies the source of the touch object as not being associated with the source electrode 38 (e.g., person 50b in seat 54b in the example of FIG. 2). In either case, the method then returns to step 702, where the touch sensor 10 and touch controller 12 are once again configured for a touch-detection mode of operation.

Although this disclosure describes and illustrates particular steps of method 700 as occurring in a particular order, this disclosure contemplates any steps including, but not limited to steps of method 700 occurring in any order. Furthermore, although this disclosure describes and illustrates particular components, devices, or systems carrying out particular steps of the method 700 of FIG. 8, this disclosure contemplates any combination of any components, devices, or systems carrying out any steps of the method 700.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
a touch sensor comprising a plurality of electrodes distributed across an area of the touch sensor;
a source electrode embedded in a chair, the source electrode connectable to a signal source, the source electrode positioned to inject one or more signals generated by the signal source through an occupant of the chair to one or more of the electrodes of the touch sensor when the occupant of the chair is electrically coupled to the area of the touch sensor; and
a touch controller configured to:
detect a position of a touch object within the area of the touch sensor during a period of time when an injected signal generated by the signal source is present on one or more of the plurality of electrodes; and
determine whether the touch object is associated with the occupant of the chair based at least in part on a proximity of the injected signal present on one or more of the plurality of electrodes to the detected position of the touch object.

2. The system of claim 1 wherein the electrical coupling of the occupant of the chair to the area of the touch sensor comprises a capacitive coupling.

3. The system of claim 1 wherein the electrical coupling of the occupant of the chair to the area of the touch sensor comprises a galvanic coupling.

4. An apparatus comprising:
one or more processors; and
one or more memory units coupled to the one or more processors, the one or more memory units collectively storing logic configured to, when executed by the one or more processors, cause the one or more processors to perform operations comprising:
detecting a position of a touch object within an area of a touch sensor during a period of time when an injected signal is present on one or more of a plurality of electrodes of the touch sensor, the injected signal generated by a signal source and electrically coupled to the touch sensor through a source electrode distinct from the plurality of electrodes of the touch sensor; and
identifying a source of the touch object based at least in part on a proximity of the injected signal present on one or more of the plurality of electrodes to the detected position of the touch object.

5. The apparatus of claim 4 wherein the logic is further configured to, when executed by the one or more processors, cause the one or more processors to detect the position of the touch object by performing operations comprising:
acquiring, from a first electrode of the plurality of electrodes, a first signal and a second signal; and
processing the first and second signals to suppress the injected signal.

6. The apparatus of claim 5 wherein the second signal is acquired within a predetermined time from the acquisition of the first signal and has a polarity that is an inverse of a polarity of the first signal.

7. The apparatus of claim 4 wherein:
the injected signal has a dominant frequency; and
the logic is further configured to, when executed by the one or more processors, cause the one or more processors to perform operations comprising detecting the presence of the dominant frequency on one or more of the plurality of electrodes to determine the proximity of the injected signal present on one or more of the plurality of electrodes to the detected position of the touch object.

8. The apparatus of claim 7 wherein the logic is further configured to, when executed by the one or more processors, cause the one or more processors to perform operations comprising processing a signal acquired from one or more of the plurality of electrodes using a frequency sensitive algorithm to detect the presence of the dominant frequency on one or more of the plurality of electrodes.

9. The apparatus of claim 4 wherein:
the source electrode is embedded in a chair; and
the logic is further configured to, when executed by the processor, perform operations comprising identifying the source of the touch object by determining whether the touch object is associated with an occupant of the chair.

10. The apparatus of claim 4 wherein the electrical coupling of the injected signal to the touch sensor comprises a galvanic coupling.

11. The apparatus of claim 4 wherein the electrical coupling of the injected signal to the touch sensor comprises a capacitive coupling.

12. A method comprising:
detecting a position of a touch object within an area of a touch sensor during a period of time when an injected signal is present on one or more of the plurality of electrodes of the touch sensor, the injected signal generated by a signal source and electrically coupled to the touch sensor through a source electrode distinct from the plurality of electrodes of the touch sensor; and
selecting, after detecting the position of the touch object, an action from a predetermined set of actions based at least in part on the presence of the injected signal during the period of time.

13. The method of claim 12 wherein the selected action comprises disregarding a detected touch.

14. The method of claim 12 wherein the selection of the action from the predetermined set of actions is further based at least in part on proximity of the injected signal to the detected position of the touch object.

15. The method of claim 12 wherein detecting the position of the touch object comprises:
acquiring, from a first electrode of the plurality of electrodes, a first signal and a second signal from a first electrode of the plurality of electrodes; and
processing the first and second signals to suppress the injected signal.

16. The method of claim 15 wherein the second signal is acquired within a predetermined time from the acquisition of the first signal and has a polarity that is an inverse of a polarity of the first signal.

17. The method of claim 14 wherein the injected signal has a dominant frequency, and further comprising determining the proximity of an injected signal present on one or more of the plurality of electrodes to the detected position of the touch object by detecting the presence of the dominant frequency on one or more of the plurality of electrodes.

18. The method of claim 17 wherein detecting the presence of the dominant frequency on one or more of the plurality of electrodes comprises processing a signal acquired from one or more of the plurality of electrodes using a frequency sensitive algorithm.

19. The method of claim 12 wherein the source electrode is embedded in a chair, and further comprising identifying the source of the touch object by determining whether the touch object is associated with an occupant of the chair.
